(19) United States
(12) Patent Application Publication
(10) Pub. No.: US 2012/0032961 A1
(43) Pub. Date: Feb. 9, 2012

(54) RATING TOOL

(76) Inventors: Richard L. Smith, Pinckney, MI (US); Maria Ford Conliffe, Farmington Hills, MI (US); Julie Lavender, Ann Arbor, MI (US); Celeste Woebkenberg, Canton, MI (US); Shawn Otto, Hudson, OH (US); Marsha L. Lind, Woodhaven, MI (US); Bernard Gray, Wonga Park (AU); Lynne Miller, Hertfordshire (GB); Jason M. Dubey, Sterling Heights, MI (US); Meg Dieringer, Novi, MI (US)

(21) Appl. No.: 12/852,694

(22) Filed: Aug. 9, 2010

(51) Int. Cl. G06T 11/20

(52) U.S. Cl. 345/440

(57) ABSTRACT

A table having a plurality of records is displayed, each of the records including at least an identifier for an entity, and at least two fields that each include a mechanism for indicating a score of a component in a rating for the entity. Input is received relating to more than one of the entities, via the mechanisms, indicating values for the scores. A rating is generated for each of the entities according to the scores for each of the entities. In the display of a computing device, a graph is provided including a substantially horizontal x-axis and a substantially vertical y-axis, axis. The ratings are plotted on the graph. The graph includes a plurality of curves, areas on the graph between the curves represent categories for the ratings, and each of the x-axis and the y-axis represent a range of values of scores of one of the rating components.

### BACKGROUND INFORMATION

Many organizations have a need for reviewing ratings and evaluations of employees, suppliers, materials, equipment, etc. Further, many organizations want or need to be able to compare ratings and evaluations of like entities. For example, it may be desirable to review ratings of a group of employees together so that a collective review of ratings may allow the organization to set thresholds for promotions, bonuses, retention, etc. Unfortunately, efficient and effective mechanisms for collectively reviewing ratings of entities, such as employee ratings, are presently lacking.

### BRIEF DESCRIPTION OF THE DRAWINGS

FIG. 1 illustrates an exemplary system for reviewing employee ratings.

FIG. 2A is a portion of a screenshot providing an exemplary illustration of a graphical user interface included in the system of FIG. 1.

FIG. 2B illustrates an exemplary ratings display area included in the screenshot of FIG. 2A.

FIG. 2C illustrates an exemplary ratings table included in the screenshot of FIG. 2A.

FIG. 3 illustrates an exemplary results display that may be provided by the ratings module of FIG. 1.

FIG. 4 illustrates an exemplary process for operation of the system of FIG. 1.

### DETAILED DESCRIPTION OF PREFERRED EMBODIMENTS

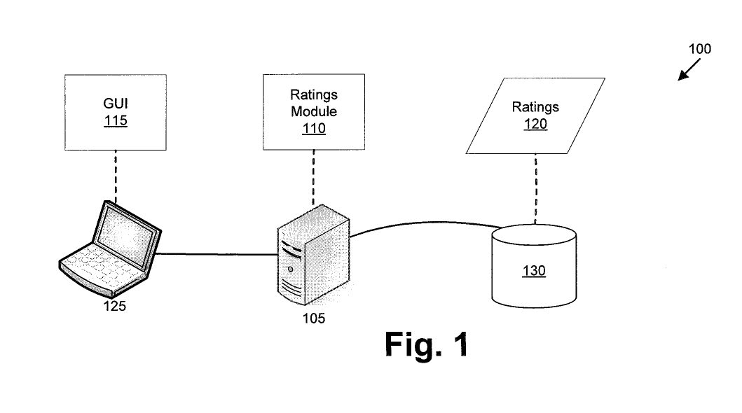

FIG. 1 illustrates an exemplary system 100 for reviewing ratings of a set of entities, such as employee ratings. Note that, although the system 100 is largely discussed herein as facilitating a review of employee ratings, ratings of many entities could be reviewed using the system 100, such as supplier ratings, materials ratings, equipment ratings, and many other kinds of ratings.

The system 100 includes a ratings computer 105, which in turn generally includes a ratings module 110. The computer 105 is usually a general-purpose computing device having an operating system such as is the Windows operating system to facilitate the execution of instructions by a processor within the computer 105. The ratings module 110 generally includes a set of computer-executable instructions stored on a non-transitory computer-readable medium included within, or accessible by, the computer 105. Instructions included within the ratings module 110 include instructions for providing a graphical user interface (GUI) 115, and for performing other operations with respect to a set of ratings 120, as described herein.

A user may access the GUI 115 via a client computer 125. For example, ratings computer 105 could include a web server or the like configured to provide the GUI 115 to a user via a web browser or the like included on client computer 125. A user could also access the GUI 115 using other mechanisms and/or devices, and the client computer 125 could be omitted from the system 100 altogether.

In one implementation, GUI 115 may be provided to a user accessing ratings computer 105 directly. For example, ratings module 110 could be implemented in a software program such as Excel provided by Microsoft Corporation of Redmond, Wash. In this example, ratings module 110 would be implemented using code written in Visual Basic for Applications (VBA). However, ratings module 110 could include instructions generated according to a variety of programming and/or scripting languages, such as Java, C++, etc.

Ratings 120 may be stored in a data store 130. The ratings 120 may have two components in that they are based on scores for each of a plurality of employees in two categories. For example, in one implementation, a first ratings 120 component is “performance to objectives,” and is a score of how well the employee has performed with respect to objectives established for that employee. To give just a few examples, objectives could include achieving technical mastery in a certain domain, performing within a budget, achieving a specified set of deliverables, achieving a certain level of client satisfaction, etc. A second component of employee ratings 120 in this exemplary implementation is “behaviors.” To give just a few examples of items in this category, behaviors could include attendance record, timeliness with respect to which work is performed, ability to work well on a team, etc.

Accordingly, a component of ratings 120 may be derived or generated from one or more scores of items relevant to the component of ratings 120. For example, a rating 120 for an employee's performance to objectives could be the average of a set of scores for the employee with respect to achieving technical mastery in a certain domain, performing within a budget, achieving a specified set of deliverables, achieving a certain level of client satisfaction, etc. Such scores may be stored with ratings 120, e.g., in data store 130, in a file generated by ratings module 110 that may also include ratings 120, etc.

Scores used to generate ratings 120 may be provided by a user with an input device, e.g., a keyboard, or according to an input mechanism such as controls provided via GUI 115, as described in more detail below. Further, ratings 120 could be provided by a user of ratings module 110, e.g., with an input device such as a keyboard. For example, in an implementation in which ratings module 110 is provided via Microsoft Excel, a user could enter ratings 120 for each of a set of employees directly into an Excel spreadsheet. Alternatively, ratings 120 could be generated within the Excel spreadsheet based on scores relevant to the ratings 120 provided within the Excel spreadsheet, or some other Excel spreadsheet. Accordingly, ratings 120, and/or scores used to generate ratings 120, could be stored in an Excel file.

Ratings computer 105, client 125, and data store 130 may communicate via a variety of mechanisms, such as an Internet protocol (IP) network such as a local area network, wide area network (e.g., the Internet), etc. Alternatively, one or more of ratings computer 105, client 125, and a data store 130 may be included within a single computing device. For example, although not illustrated, data store 130 could be included within a non-transitory computer-readable medium within computer 105. Likewise, as discussed above, operations described herein with respect to client 125 could include a user accessing ratings computer 105 directly, and client 125 could be omitted from system 100.

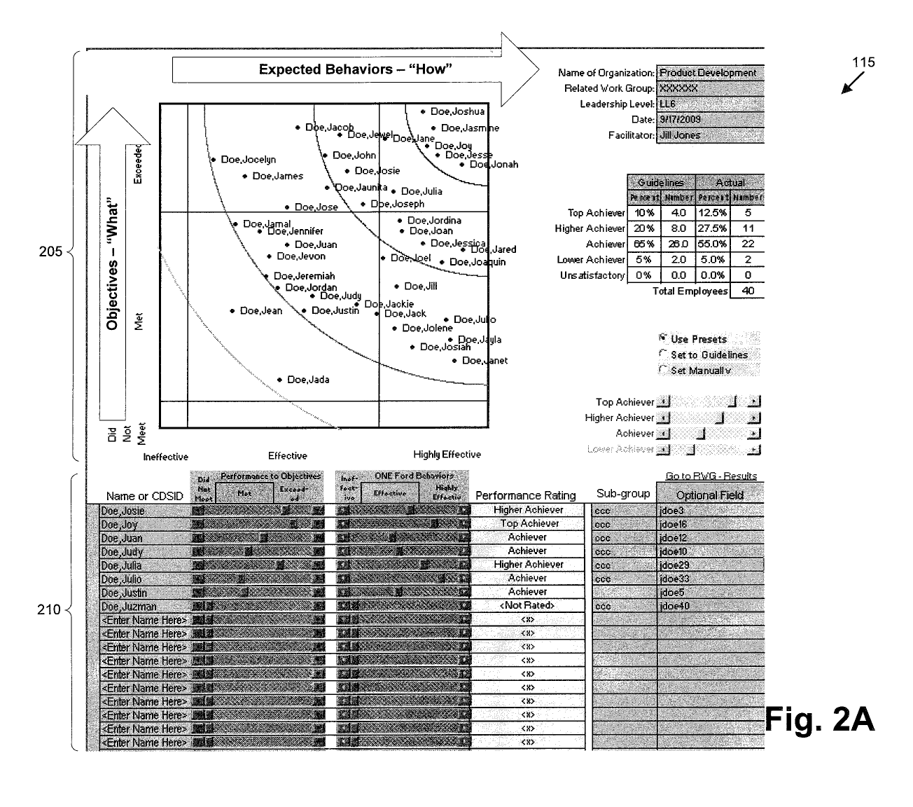

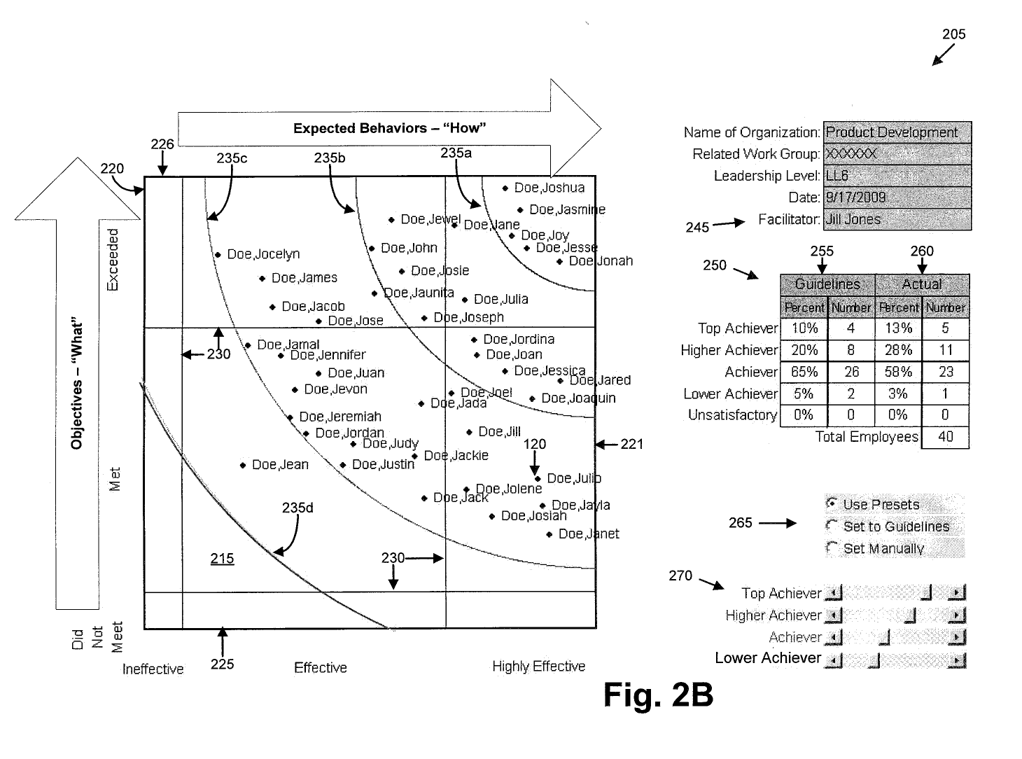

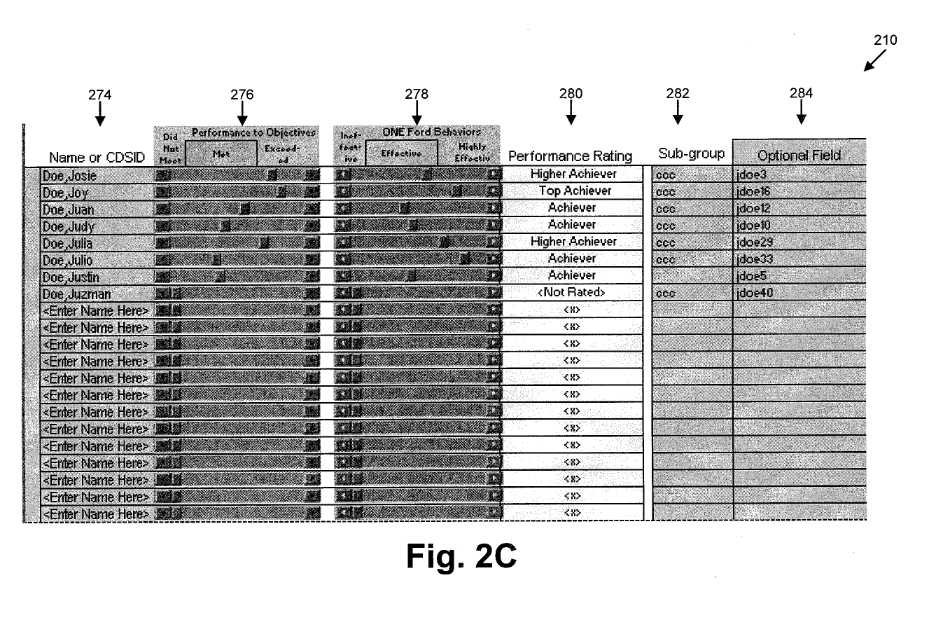

FIG. 2A is a portion of a screenshot providing an exemplary illustration of GUI 115. Two main areas of GUI 115 are shown in FIG. 2A: a ratings display area 205, and a ratings table 210. An exemplary ratings display area 205 is described in more detail below with respect to FIG. 2B. An exemplary ratings table 210 is described in more detail below with respect to FIG. 2B.

As can be seen in FIG. 2B, ratings display area 205 includes a ratings graph 215 that presents a scatter plot of ratings 120, each rating 120 being labeled according to the name of an employee associated with the respective rating 120. The graph 215 includes y-axis 220 and x-axis 225. The y-axis 220 represents values for a first component of a rating 120, and the x-axis 225 represents values for a second component of the rating 120. For example, as illustrated in FIG. 2B, the y-axis 220 represents and “objectives” component of a rating 120, and the x-axis 225 represents a “behaviors” component of the rating 120. The graph 215 is further generally bounded by a substantially horizontal line 226 generally parallel to the x-axis 225, and a substantially vertical line 221 generally parallel to the y-axis 220. Thus, graph 215 is substantially rectangular, and usually square, in shape.

Grid lines 230, each grid line 230 being substantially parallel to either y-axis 220 or x-axis 225 and generally also to at least one other grid line 230, are included on graph 215 to identify rectangles on the graph 215 related to certain values for ratings 120. For example, as illustrated, an “objectives” component of a rating 120 could have a value reflecting that an employee did not meet the objectives, met the objectives, or exceeded the objectives. Similarly, a “behaviors” component of a rating 120 could have a value reflecting that the behaviors of the employee were ineffective, effective, or highly effective. Note that the grid lines 230 shown in FIG. 2B are not evenly distributed because it is expected that more employee ratings 120 will fall within certain ranges than others, and it is desired to be able to display each rating 120 at an appropriate intersection of values on the x and y axes, e.g., of behaviors and objectives. For example, more employees fall within the intersection of “effective” behaviors and “met” objectives than fall within “highly effective” behaviors and “exceeded” objectives. Similarly, no employees fall within the intersection of “ineffective” behaviors and “did not meet” objectives.

In general, grid lines 230 may be arranged in whatever fashion warrants and to accommodate an expected distribution of ratings 120. Further, as illustrated in FIG. 2B, and as explained above, to accommodate expectations concerning where employee ratings 120 will fall on graph 215, the grid lines 230 are not evenly distributed on graph 215. Instead, each grid line 230 is a different distance from the axis of graph 215 to which it is parallel and the other grid line 230 or grid lines 230 to which it is parallel.

Also included on graph 215 for the purpose of grouping ratings 120 are curves 235. For example, a first curve 235a delineates ratings 120 associated with top achieving employees. Ratings 120 falling between the curve 235a and a curve 235b are associated with higher achieving employees. Ratings 120 falling between the curves 235b and 235c are associated with achieving employees, and ratings 120 falling between the curves 235c and 235d are associated with lower achieving employees. In the example of FIG. 2B, no ratings 120 fall to the left of the curve 235d, but if any did, these would be associated with unsatisfactory employees.

In the exemplary implementation discussed herein, curves 235 are concentric circles. The circles have varying radii, but a common center, the common center being located at an intersection of the lines 221 and 226. Placement of one or more curves 235 on graph 215 may be adjusted, e.g., in response to inputs to module 110, as discussed below.

Ratings distribution table 250, seen in FIG. 2B below metadata information 245, includes ratings distribution guidelines 255, and also actual ratings distribution 260.

Guidelines 255 include a “percent” column and a “number” column. The percent column indicates a percentage of employees whose ratings should fall into each of the indicated categories (top achiever, higher achiever, achiever, lower achiever, and unsatisfactory). Note that the categories correspond to the categories discussed above as delineated by curves 235. The number column in guidelines 255 indicates a number of employees, based on a total number of employees in an organization, e.g., a department, workgroup, etc., falling into the listed categories. In general, guidelines 255 may be developed by an organization to reflect a desire to distribution of ratings 120.

The actual ratings distribution 260 also includes a “percent” column and a “number” column. The percent column of actual distribution 260 includes an actual percentage of employees that fall into each of the listed categories. The number column of actual distribution 260 includes an actual number, out of a total number, of employees falling into each of the listed categories. Thus, the number of employees identified for each listed category should match the number of ratings 120 in the respective areas defined by curves 235. For example, actual distribution 260 lists five employees as falling into the top achiever category, and five ratings 120 can be seen to the right of curve 235a on graph 215.

Threshold control 265 may be used to determine placement of curves 235. Threshold control 265 may be a set of radio buttons, as illustrated in FIG. 2B, or may be some other type of control for allowing a user to select among a set of options. Threshold control 265 may be set by default to select to use preset locations of curves 235. For example, by default, curves 235 may be located equidistant from one another on graph 215.

Threshold control 265 may also allow a user to select circle segments 235 to be “set to guidelines.” That is, curves 235 may be placed on graph 215 to reflect guidelines 255 that, as discussed above, identify a number, and percentage, of employees that should fall into each of a set of categories of ratings 120, based on a total number of employees in a group being evaluated.

Further, threshold control 265 may allow a user to select to manually that is, a user may wish to determine manually the numbers and percentages of employees falling into each of the categories established for ratings 120. In this case, threshold adjustment controls 270 may be used to determine the placement of curves 235 on graph 215. As illustrated in FIG. 2B, threshold adjustment controls 270 are slider controls that may be adjusted to govern the placement of each of the curves 235 placed on graph 215.

Ratings display area 205 includes metadata information 245. For example, metadata information 245 may include a description or identifier for an organization generating ratings 120, and other information related to the ratings 120, and their evaluation.

FIG. 2C provides an exemplary illustration of a ratings table 210, including name column 274, objectives column 276, behaviors column 278, rating column 280, subgroup column 282, and optional column 284.

Name column 274 includes a name of an employee being rated. Alternatively or additionally, column 274 could include a unique or substantially unique identifier for the employee.

Objectives column 276 includes a control, e.g. a slider control, for setting a score of an objectives component of a rating 120. Some other kind of mechanism could be used, such as an box for entering alphanumeric text or the like. As can be seen, the control can be set to a range of scores, falling into the categories did not meet objectives, met objectives, and exceeded objectives. It is to be understood that a range of scores may be possible within each of these categories. Further, with reference back to FIG. 2A, when a control in objectives column 276 is adjusted, a score for one of the components for the rating 120 is updated, and accordingly the rating 120 may be adjusted on graph 215 with respect to y-axis 220. For example, when a slider control is moved toward the “did not meet” end of the score spectrum, the rating 120 for the employee in question may be moved vertically lower on graph 215, i.e., closer to x-axis 225. Accordingly, ratings 120 may be updated and re-plotted on graph 215 according to adjustment of controls included in GUI 115, e.g., in table 210.

Behaviors column 278 likewise includes a control for setting a score of a behaviors component of a rating 120. For example, a score of a behaviors component may be categorized as “ineffective,” “effective,” or “highly effective.” It is to be understood that a range of scores may be possible within each of these categories. Moreover, when the control is adjusted, a rating 120 for the employee in question may be moved on graph 215 with respect to x-axis 225. For example, if the control is moved to set the behavior score closer to the “ineffective” end of the behaviors spectrum, the rating 120 may be moved closer to y-axis 220.

Ratings column 280 identifies the category of the rating 120 associated with the employee in question. The identified category, e.g., “higher achiever,” “top achiever,” etc., should correspond to the placement of the rating 120 for the employee on graph 215. For example, if the employee is a “top achiever,” then the rating 120 for the employee should be placed on graph 215 to the right of circle segment 235a. Moreover, as controls in objectives column 276 and/or behaviors column 278 are adjusted, an indication of a rating 120 in ratings column 280 may be changed according to instructions in module 110. For example, as a slider control in objectives column 276 is moved to the left, an indication of a rating 120 in ratings column 280 may change from “higher achiever” to “achiever.”

Subgroup column 282 may be used to identify a subgroup to which an employee belongs. For example, an employee may be evaluated within the context of the employee's department, but may also belong to a workgroup or other sub-organization within the department. Therefore, subgroup column 282 may be used to identify a sub-organization to which the employee belongs.

Optional field 284 may be provided, along with other optional fields as deemed necessary or convenient, to include other information associated with an employee record. For example, as illustrated in FIG. 2C, optional field 284 may be used to include a unique or substantially unique identifier for the employee if such identifier is not found in name column 274.

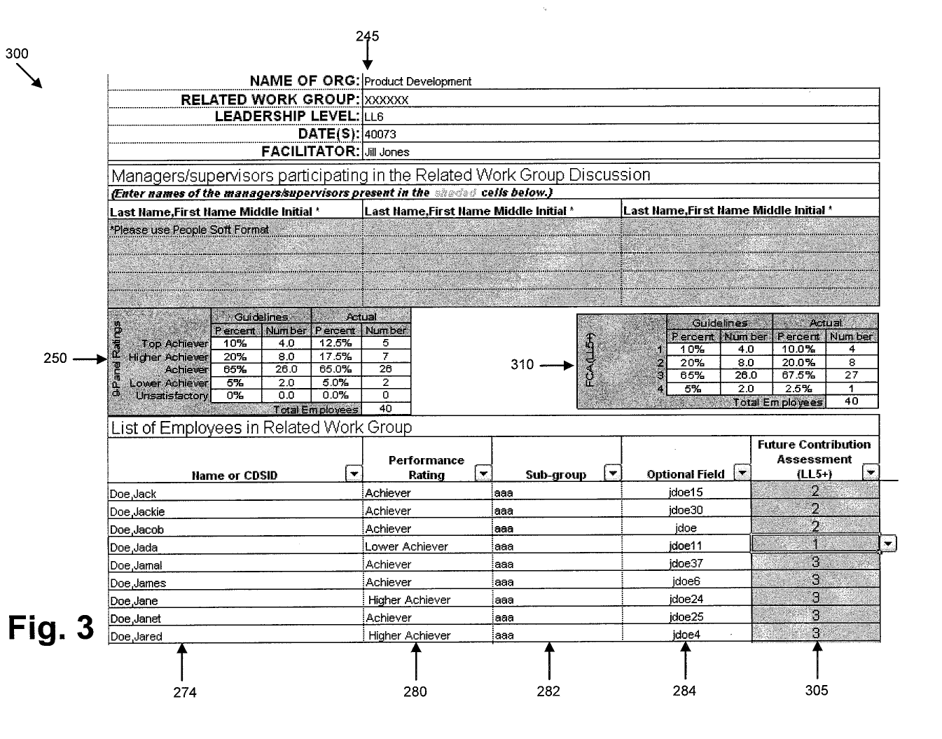

FIG. 3 illustrates a results display 300 that may be provided by ratings module 110, e.g., in GUI 115. As can be seen, the results display 300 includes certain elements discussed above with respect to ratings display area 205 and/or ratings table 210. The results display 300 may be generated by ratings module 110 upon an indication by a user, e.g., using a button, link, or some other control (not shown in the figures) that the display area 205 and ratings table 210 include an evaluation of employees in the relevant departments, workgroup, etc. that are complete and ready for publication, reporting, or the like.

In addition to elements discussed above, results display 300 may include a future contribution assessment column 305. A future contribution assessment is an estimate or score of an employee's potential for future positive contributions to an organization. In the implementation illustrated in FIG. 3, future contribution assessment is scored on a scale of 1 to 4, with for being a higher, or better, future contribution assessment. A future contribution assessment may be determined by a reviewer according to a performance rating and/or other information about an employee, and may be entered into using a control such as a drop-down list box or the like. Alternatively, a future contribution assessment may be generated by module 110 according to a rating 120, or a history of ratings 124 and employee. For example, employees who have received higher ratings, e.g., higher achiever or top achiever, for a predetermined number of years, may be eligible for a higher future contribution assessment, and such eligibility may be included in instructions in module 110.

The display 300 may also include a future contribution assessment distribution table 310. Similar to ratings distribution table 250, future contribution assessment distribution table 310 may provide guidelines for a distribution of future contribution assessments in an organization, along with an actual distribution of future contribution assessments for employees in the organization.

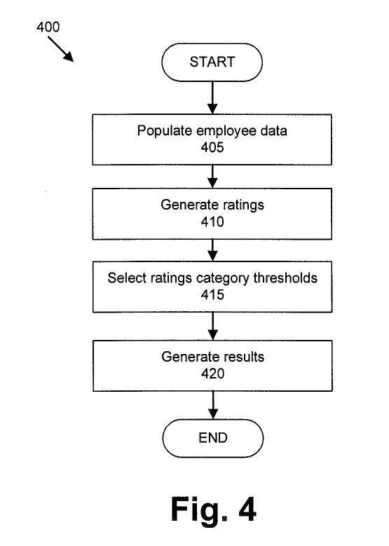

FIG. 4 illustrates an exemplary process 400 for operation of the system 100. The process 400 begins in a step 405, in which employees for evaluation are identified. For example, employees for a workgroup, department, etc. may be identified according to a list (not shown) of such employees maintained in data store 130, or some other data store. Alternatively or additionally, information identifying employees may be entered by a user through GUI 115, e.g., into name column 274, or may be provided from a file, such as a text file, and Excel file, etc.

Further alternatively or additionally, a rating 120 may include an identifier for an employee with whom the rating 120 is associated. Thus, in one implementation, ratings 120 may be included in data store 130, and may then be retrieved from data store 130 by ratings module 110 for display in GUI 115 and/or for further processing as described herein.

In any event, in step 405, GUI 115 is populated with data relating to a set of employees, including at least an identifier or description for the employee, along with possibly other information, such as information included in subgroup column 282 as discussed above, or information included in optional field 284, also discussed above.

Next, in step 410, ratings 120 are generated. For example, as has been discussed, ratings 120 may be manually generated by operating controls included in objectives column 276 and behaviors column 278 in ratings table 210. Alternatively or additionally, as has also been discussed, ratings 120 may be retrieved from data store 130.

Next, in step 415, thresholds for ratings categories are selected. For example, as explained above, threshold control 265 may be used to indicate a mode of selecting thresholds for categories of ratings 120, e.g., as indicated by placement of circle segments 235 on graph 215. If preset thresholds, or thresholds according to predetermined guidelines, are selected, then no further action need be taken to establish thresholds. However, thresholds may also be set according to user input to module 110. For example, as discussed above, threshold adjustment controls 270 may be used to adjust or establish thresholds for ratings 120 categories.

Next, in step 420, results of evaluating employees according to ratings 120 are provided, e.g., in results display 300.

Following step 420, process 400 ends.

Computing devices such as computer 105, etc., generally each include instructions executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases or data stores described herein may include various kinds of mechanisms for storing, accessing, and retrieving various kinds of data, including a hierarchical database, a set of files in a file system, an application database in a proprietary format, a relational database management system (RDBMS), etc. Each such database or data store is generally included within a computing device employing a computer operating system such as one of those mentioned above, and are accessed via a network in any one or more of a variety of manners. A file system may be accessible from a computer operating system, and may include files stored in various formats. An RDBMS generally employs Structured Query Language (SQL) in addition to a language for creating, storing, editing, and executing stored procedures, such as the PL/SQL language mentioned above. A database or data store may be any of a variety of known RDBMS packages, including IBM's DB2, or the RDBMS provided by Oracle Corporation of Redwood Shores, Calif.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary is made herein.

What is claimed is:

1. A method, comprising:
providing, in a display of a computing device, a table having a plurality of records, each of the records including at least an identifier for an entity, and at least two fields that each include a mechanism for indicating a score of a component in a rating for the entity;
receiving input relating to more than one of the entities, via the mechanisms, indicating values for the scores;
generating a rating for each of the entities according to the scores for each of the entities;
providing, in the display of a computing device, a graph including a substantially horizontal x-axis and a substantially vertical y-axis, axis; and
plotting the ratings on the graph;
wherein the graph includes a plurality of curves, areas on the graph between the curves represent categories for the ratings, and each of the x-axis and the y-axis represent a range of values of scores of one of the rating components.

2. The method of claim 1, the table including a further field that includes the rating.

3. The method of claim 1, wherein the graph further includes a plurality of gridlines, each of the gridlines parallel to one of the x-axis or the y-axis and at least one other of the gridlines, wherein each of the gridlines is a different distance from the axis to which it is parallel and the other of the gridlines to which it is parallel.

4. The method of claim 1, wherein the curves are segments of concentric circles, the concentric circles being of varying radii and having their center defined by an intersection of a substantially horizontal line substantially parallel to the x-axis and a substantially vertical line substantially parallel to the y-axis.

5. The method of claim 1, wherein the mechanism is a control, the method further comprising determining a placement of at least one of the curves on the graph based on input received according to adjustment of a control.

6. The method of claim 5, further comprising:
receiving an input based on adjustment of a control;
updating the score associated with the control;
updating the rating associated with the score; and
re-plotting the rating on the graph.

7. The method of claim 1, further comprising determining a placement of the curves on the graph based on predetermined guidelines.

8. A non-transitory computer-readable medium tangibly embodying computer-executable instructions, including instructions for:
providing, in a display of a computing device, a table having a plurality of records, each of the records including at least an identifier for an entity, and at least two fields that each include a mechanism for indicating a score of a component in a rating for the entity;
receiving input relating to more than one of the entities, via the mechanisms, indicating values for the scores;
generating a rating for each of the entities according to the scores for each of the entities;
providing, in the display of a computing device, a graph including a substantially horizontal x-axis and a substantially vertical y-axis, axis; and
plotting the ratings on the graph;
wherein the graph includes a plurality of curves, areas on the graph between the curves represent categories for the ratings, and each of the x-axis and the y-axis represent a range of values of scores of one of the rating components.

9. The medium of claim 8, the table including a further field that includes the rating.

10. The medium of claim 8, wherein the graph further includes a plurality of gridlines, each of the gridlines parallel to one of the x-axis or the y-axis and at least one other of the gridlines, wherein each of the gridlines is a different distance from the axis to which it is parallel and the other of the gridlines to which it is parallel.

11. The medium of claim 8, wherein the curves are segments of concentric circles, the concentric circles being of varying radii and having their center defined by an intersection of a substantially horizontal line substantially parallel to the x-axis and a substantially vertical line substantially parallel to the y-axis.

12. The medium of claim 8, wherein the mechanism is a control, the method further comprising determining a placement of at least one of the curves on the graph based on input received according to adjustment of a control.

13. The medium of claim 12, the instructions further including instructions for:
receiving an input based on adjustment of a control;
updating the score associated with the control;
updating the rating associated with the score; and
re-plotting the rating on the graph.

14. The medium of claim 8, further comprising determining a placement of the curves on the graph based on predetermined guidelines.

15. A system, comprising a computing device configured to:
provide, in a display of a computing device, a table having a plurality of records, each of the records including at least an identifier for an entity, and at least two fields that each include a mechanism for indicating a score of a component in a rating for the entity;
receive input relating to more than one of the entities, via the mechanisms, indicating values for the scores;
generate a rating for each of the entities according to the scores for each of the entities;
provide, in the display of a computing device, a graph including a substantially horizontal x-axis and a substantially vertical y-axis, axis; and
plot the ratings on the graph;
wherein the graph includes a plurality of curves, areas on the graph between the curves represent categories for the ratings, and each of the x-axis and the y-axis represent a range of values of scores of one of the rating components.

16. The system of claim 15, the table including a further field that includes the rating.

17. The system of claim 15, wherein the graph further includes a plurality of gridlines, each of the gridlines parallel to one of the x-axis or the y-axis and at least one other of the gridlines, wherein each of the gridlines is a different distance from the axis to which it is parallel and the other of the gridlines to which it is parallel.

18. The system of claim 15, wherein the curves are segments of concentric circles, the concentric circles being of varying radii and having their center defined by an intersection of a substantially horizontal line substantially parallel to the x-axis and a substantially vertical line substantially parallel to the y-axis.

19. The system of claim 15, wherein the mechanism is a control, the method further comprising determining a placement of at least one of the curves on the graph based on input received according to adjustment of a control.

20. The system of claim 19, the computing device further configured to:
receive an input based on adjustment of a control;
update the score associated with the control;
update the rating associated with the score; and
re-plot the rating on the graph.

21. The system of claim 15, further configured to determine a placement of the curves on the graph based on predetermined guidelines.
